(19) United States
(12) Patent Application Publication
(10) Pub. No.: US 2026/0111787 A1
(43) Pub. Date: Apr. 23, 2026

(54) Automatic Retraining Of Machine Learning Models Upon Data Deletion

(71) Applicant: Zoom Communications, Inc., San Jose, CA (US)

(72) Inventors: Xu Hua Li, San Jose, CA (US); Zhoujun Zhang, Hangzhou (CN)

(21) Appl. No.: 18/918,791

(22) Filed: Oct. 17, 2024

(51) Int. Cl. G06N 20/00; G06F 21/62

(52) U.S. Cl. CPC G06N 20/00; G06F 21/6245

(57) ABSTRACT

Machine learning models trained using personal data are automatically retrained upon deletion of the personal data. A system identifies a first data set including personal data and used to train a machine learning model. The system deletes the personal data from a data store associated with the machine learning model. The system also automatically retrains, based on deleting the personal data, the machine learning model using a second data set that excludes the personal data.

### FIELD

This disclosure generally relates to an artificial intelligence (AI) system, and, more specifically, to automatic retraining of machine learning models upon data deletion.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of an artificial intelligence (AI) system for processing user requests associated with software services of a software platform.

FIG. 5 is a block diagram of an example of a system for implementing data privacy management and automatic retraining of machine learning (ML) models upon data deletion.

FIG. 6 is a schematic block diagram of an example associated with automatic retraining of ML models upon data deletion.

FIG. 7 is a schematic block diagram of another example associated with automatic retraining of ML models upon data deletion.

FIG. 8 is a flowchart showing an example of a technique for automatic retraining of ML models upon data deletion.

FIG. 9 is a flowchart showing another example of a technique for automatic retraining of ML models upon data deletion.

### DETAILED DESCRIPTION

Enterprise entities rely upon several modes of communication to support their operations, including video conferencing, telephone, email, messaging, productivity tools, contact centers, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises solutions, meaning that remote workers and those who are generally increasingly mobile may be unable to rely upon them. One solution is by way of a unified communications as a service (UCaaS) platform, which includes several software services corresponding to multiple communications modalities integrated over a network, such as the Internet, to deliver a complete communication experience regardless of physical location. The software services of a UCaaS platform may thus enable synchronous and asynchronous communications between users. In some cases, the software services of a UCaaS platform may implement other functionality as well, for example, for using digital whiteboards, making workspace reservations, or the like. Other solutions include contact center as a service (CCaaS) and/or productivity tools, among other examples.

A software platform, such as a UCaaS platform or a CCaaS platform, may provide artificial intelligence (AI) functionality for use with the software services thereof. Use of the AI functionality may enhance the user experience by automating processes, answering prompted questions with minimal or no disruption to an active communication session, or introducing capabilities previously unavailable to software service users. Such AI functionality may be implemented using one or more machine learning (ML) models, which may be trained to process specific types of input and produce specific types of output. For example, ML functionality enabled for use during a video conference may be implemented using a large language model (LLM) trained to obtain user requests as natural language prompts and to produce output responsive to the user requests in a same language as that which the prompts are obtained. In one non-limiting example, a video conference participant who joins the video conference after it began may submit a user request to an LLM to ask for a summary of the discussion that occurred during the video conference before the participant joined. The LLM may evaluate a real-time transcription of the video conference (e.g., produced using automated speech recognition or a like tool) to present output concisely summarizing that discussion.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the rapidly evolving landscape of AI and ML, organizations increasingly rely on sophisticated models trained on vast amounts of data to power various applications and services. However, this reliance on data-driven models presents significant challenges when it comes to managing personal information and complying with data privacy regulations. As individuals become more aware of their digital footprint and the value of their personal data, there is a growing demand for greater control over how this information is used, especially in the context of ML model training.

One of the primary challenges in this domain is the difficulty in removing the influence of specific data points from trained ML models. Traditional approaches to data deletion often focus on removing raw data from databases, but this does not address the residual impact that this data may have on ML models that have been trained using it. This creates a complex problem where simply deleting data from storage systems is insufficient to fully respect an individual's right to be forgotten or to comply with data deletion requests.

Furthermore, the process of identifying and retraining ML models to exclude specific data points is typically resource-intensive and time-consuming. This can lead to significant operational challenges for organizations that need to maintain up-to-date models while also respecting user privacy and complying with regulatory requirements. The lack of efficient and automated solutions for this problem exposes organizations to potential legal and reputational risks, as well as the possibility of inadvertently using personal data in ways that individuals have not consented to or have explicitly requested to be removed.

Implementations of this disclosure address problems such as these by providing an automated system for retraining ML models when personal data used to train those models is deleted. The system tracks which personal data was used to train each model and, upon receiving a data deletion request, identifies all models trained using that data. It then automatically retrains those models using the remaining training data, effectively removing the influence of the deleted personal data. This approach allows organizations to comply with data deletion requests while preserving the utility of their ML models. The system also provides transparency to users about which models were retrained based on their data deletion request, enhancing trust and accountability. By automating the process of model retraining in response to data deletion, this solution enables organizations to efficiently manage large volumes of deletion requests, reduce legal and reputational risks associated with unauthorized data retention, and maintain compliance with evolving privacy regulations

In some examples of this disclosure, implementations may include or otherwise use one or more AI or ML (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

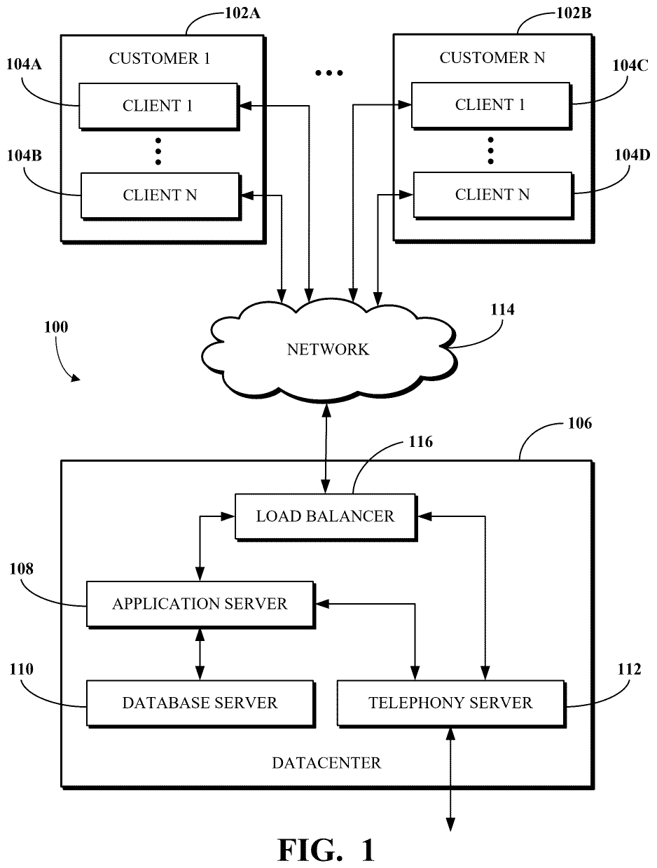

To describe some implementations in greater detail, reference is first made to examples of hardware and software structures used to implement a system for automatic retraining of ML models upon data deletion. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

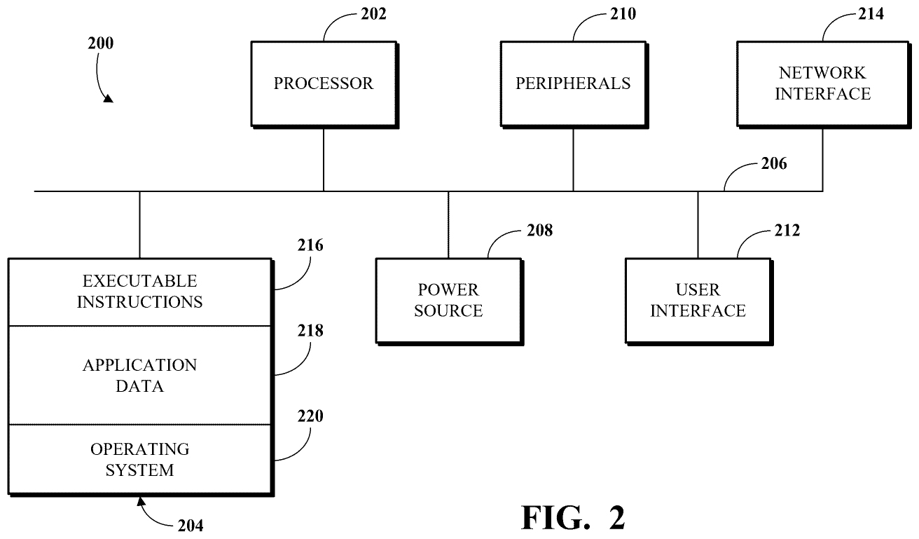

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

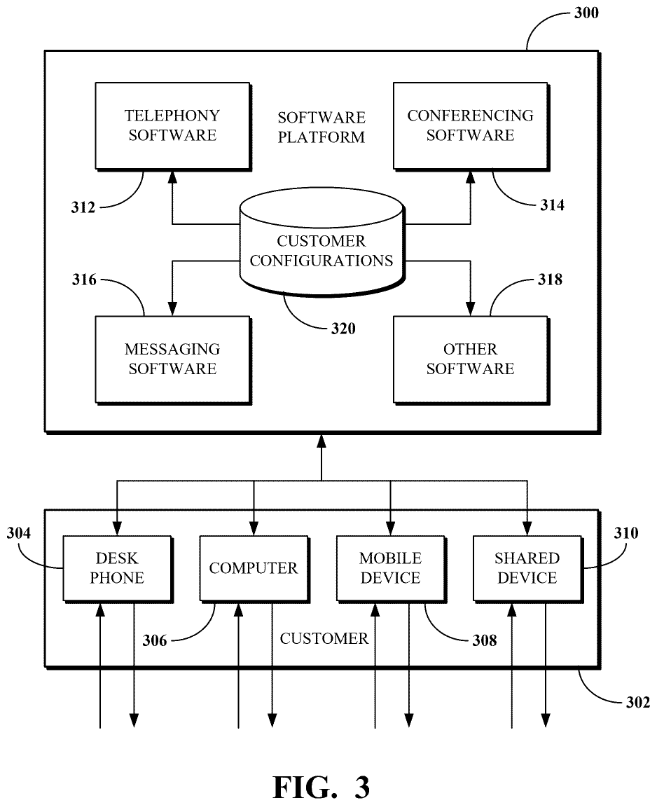

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

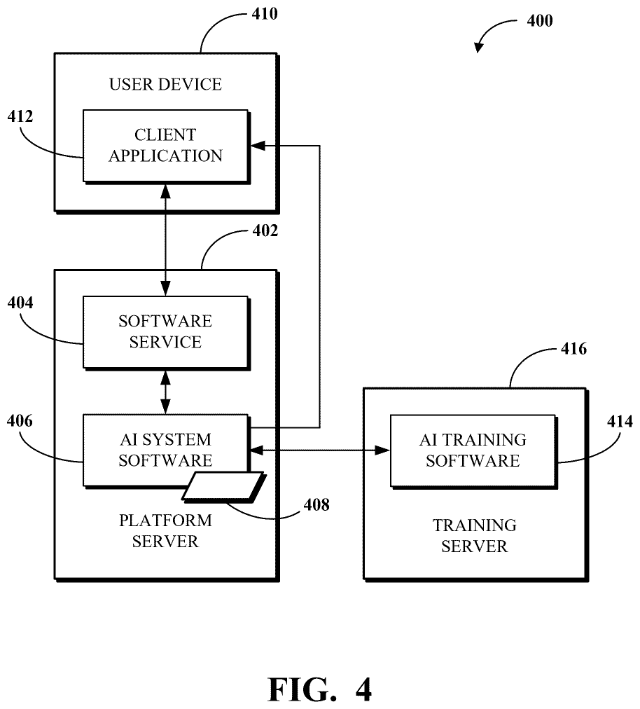

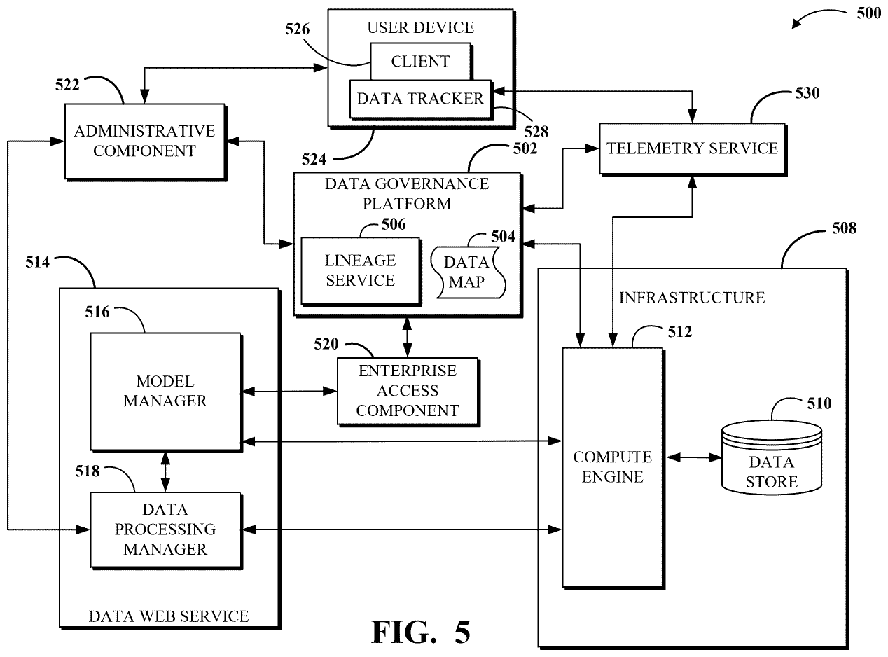

The other software 318 enables other functionality of the software platform 300. Examples of the other software 318 include, but are not limited to, device management software, resource provisioning and deployment software, administrative software, third party integration software, and the like. In one particular example, the other software 318 can include AI system software (e.g., the AI system software 406 shown in FIG. 4), AI training software (e.g., the AI training software 414 shown in FIG. 4), software for implementing a data governance platform (e.g., the data governance platform 502 shown in FIG. 5), software for implementing a model manager (e.g., the model manager 516 shown in FIG. 5), software for implementing a data processing manager (e.g., the data processing manager 518 shown in FIG. 5), and/or software for implementing a telemetry service (e.g., the telemetry service 530 shown in FIG. 5), among other examples. In some such cases, the telephony software 312, the conferencing software, and/or the messaging software 316 may include the other software 318. In other such cases, the other software 318 may be a centralized software service accessible to the telephony software 312, the conferencing software, and/or the messaging software 316.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

FIG. 4 is a block diagram of an example of an AI system 400 for processing user requests associated with software services of a software platform, such as the software platform 300 shown in FIG. 3. The AI system 400 includes a platform server device 402 that implements a software service 404, AI system software 406, and one or more ML models 408 such as one or more LLMs. For example, the platform server device 402 may include one or more application servers and/or database servers, such as the application server 108 and the database server 110 shown in FIG. 1, used to implement the software service 404, the AI system software 406, and the one or more ML models 408. In some cases, the platform server device 402 may be or otherwise include multiple servers. In such a case, the software service 404, the AI system software 406, and the one or more ML models 408 may be implemented across the multiple servers in one or more ways.

The software service 404 is, includes, or otherwise refers to the components used to run (e.g., execute or interpret) application-level software. For example, the software service 404 may facilitate synchronous or asynchronous communications, such as via one of the software services 312 through 316 shown in FIG. 3. In another example, the software service 404 may facilitate functionality directly related, indirectly related, or unrelated to synchronous or asynchronous communications, such as appointment scheduling, event hosting, knowledgebase compilation, digital whiteboarding, workspace reservation, and the like. The software service 404 may thus be one of many software services of the software platform, in which some or all of those other software services may also be implemented by the platform server device 402 or by one or more other server devices associated with the software platform.

The software service 404 is accessed by a user device 410, which is a personal or shared computing device configured to run a client application 412 associated with the software service 404. For example, the user device 410 may be one of the clients 304 through 310 shown in FIG. 3. The client application 412 may be a software application installed on the user device 410 and used to access the various software services of the software platform via one or more client-side graphical user interfaces (GUIs). Alternatively, the client application 412 may be a web-based application instantiated based on requests processed in connection with a web browser running at the user device 410. In some implementations, the client application 412 may be omitted, in which case the user device 410 may instead access the software service 404 using other web browser-based approaches or a different software application.

In one non-limiting example, the software service 404 may correspond to conferencing software (e.g., the conferencing software 314 shown in FIG. 3) for facilitating video conferences between users of user devices including the user device 410. The user of the user device 410 connects to the video conference via the client application 412, which interfaces with the software service 404 to cause the user device 410 to join the video conference and thus enable synchronous communications over video and/or audio with the users of the other user devices. For example, the client application 412 may encode a video stream captured at the user device 410 and transmit the encoded video stream for rendering at the other user devices, and it may similarly receive encoded video streams originating at those other user devices and decode same to render the video of the other user device users at the user device 410. The user of the user device 410 may similarly use the client application 412 to access related functionality of the video conference, for example, chat tools for interacting with one or more participants via text, AI tools for summarizing video conference content, and the like.

The software service 404 may receive user requests initiated at the user device 410. The user requests are related to functionality of the software service 404 and correspond to tasks to be actioned by or otherwise on behalf of the software service 404, to generate and transmit responses to the user requests. Non-limiting examples of user requests include requests to summarize video conference content, requests to schedule an appointment or reserve a workspace, requests to classify digital whiteboards by content or creator, and the like. A user request may be initiated at the user device 410 in one or more ways, including, for example, by the user device 410 obtaining input from a user thereof, such as in response to a prompt.

The AI system software 406 obtains such a user request from the software service 404 and causes the one or more ML models 408 to process the user request to produce output responsive to the user request. The AI system software 406 then transmits the output to the software service 404 for the software service 404 to present to the user device 410. In particular, the AI system software 406 orchestrates the execution of the one or more ML models 408 as part of a model chain by causing the one or more ML models 408, in sequence, to perform an inference operation to produce output based on the user request.

In some implementations, the AI system software 406 may cause an execution of one or more ML models 408 at the user device 410. For example, the client application 412 may include or otherwise obtain (e.g., download from a source external to the user device 410) executable instructions for implementing an ML model at the user device 410. In some such implementations, the one or more ML models implemented at the user device 410 may be the first ML models of the model chain. Thus, server-side user request traffic may in such cases be avoided or at least limited based on the processing of user requests being handled at the client-side.

AI training software 414 implemented on a training server 416 may be used to train and, in some implementations, retrain the one or more ML models 408. The AI training software 414 may perform any number of different types of AI training to train or retrain the one or more ML models 408. In some implementations, the training server 416 may be, be similar to, include, or be included in the platform server 402. In some other implementations, the training server 416 may be distinct from the platform server 402. The training server 416 may refer to any number of server devices and/or server instances. In some implementations, the training server 416 may refer to a federated training system. The training server 416 may include one or more servers, such as the application server 108 and the database server 110 shown in FIG. 1. In some implementations, the training server 416 may implement preference optimization software for training the one or more ML models 408.

FIG. 5 is a block diagram of an example of a system 500 for implementing data privacy management and for automatic retraining of ML models upon data deletion. The system 500 provides a technical solution by integrating various components to track, manage, and control data flow and access across multiple services and devices. The system 500 addresses the technical problem of managing personal data used in training ML models while ensuring compliance with data privacy regulations and user requests for data deletion. The technical solution provided by this disclosure includes an integrated approach that combines data governance, ML model management, and automated retraining processes.

For example, the system 500 provides an automated system for retraining ML models when personal data used to train those models is deleted. The system 500 tracks which personal data was used to train each model and, upon receiving a data deletion request, identifies all models trained using that data. It then automatically retrains those models using training data that excludes the personal data, effectively removing the influence of the deleted personal data. This approach allows organizations to comply with data deletion requests while preserving the utility of their ML models. The system also may provide transparency to users about which models were retrained based on their data deletion request, enhancing trust and accountability.

As shown, the system 500 includes a data governance platform 502. As used herein, the term “data governance platform” may refer to a software system configured to manage, monitor, and control data-related processes and policies within an organization. The data governance platform 502 may be, be similar to, include, or be included in the platform server 402 shown in FIG. 4, the software platform 300 shown in FIG. 3, the computing device 200 shown in FIG. 2, and/or the datacenter 106 shown in FIG. 1, among other examples. The data governance platform 502 may include various components and services designed to ensure data quality, security, and compliance. For example, the data governance platform 502 may implement data classification algorithms, access control mechanisms, and audit logging capabilities.

The data governance platform includes a lineage service 506 configured to generate and manage a data map 504 that tracks a lineage of data that may be subject to data privacy protections. The lineage of a set of data may refer to information indicative of an origin of the set of data, movement of the set of data (from one device to another), any relationships between the set of data and other data or processes, any access to the set of data, any transformation of the set of data, and/or any copying of the set of data, among other examples.. As used herein, the term “data map” may refer to a representation of data locations, (e.g., a data source or location of origination, a data flow, etc.), data transformation, data lineage, or data event history associated with a set of data. As used herein, the term “data event” may refer to any occurrence or action related to data, such as a data upload event, a data download event, or a data movement event. A “telemetry event” may refer to any event related to the collection or transmission of data, particularly in the context of software development or application usage.

The lineage service 506 may be configured to obtain data event information indicative of a data event associated with a set of data. The data event information may comprise a set of metadata corresponding to the set of data. The set of metadata may include location information associated with at least one location of the set of data. For example, the location information may include a physical address associated with the at least one location of the set of data, a network address associated with the at least one location of the set of data, or both. The lineage service 506 generates or updates the data map 504 based on the location information. The set of metadata may also include a data source identifier associated with the set of data, a data classification associated with the set of data, a data access permission associated with the set of data, or a combination thereof. For example, when a user uploads a file to the system, the lineage service 506 may record metadata such as the file size, upload time, source IP address, and destination storage location. The data map 504 may include information such as physical or network addresses of data storage locations, data movement paths, and data access patterns. For instance, the data map 504 may track how a particular dataset moves from a user device through various processing stages and ultimately to long-term storage.

In some implementations, the data governance platform 502 may be configured to respond to queries associated with data location. In some implementations, the data governance platform 502 may automate personal data audits and telemetry privacy impact assessments. For example, the data governance platform 502 may receive a data location query indication associated with the set of data. The data location query indication may be a privacy impact assessment (PIA) request associated with the set of data, a data subject access request (DSAR) associated with the set of data, a data subject deletion request (DSDR) associated with the set of data, a data protection impact assessment (DPIA) associated with the set of data, or another type of request. The data governance platform 502 may provide, for output and based on the data location query indication and the data map 504, a query result. The query result may include a PIA report, a a DSAR report, a DSDR report, or another type of report. In some implementations, an engineer or an engineering software component may request collection of data and/or access to collected data. The data governance platform 502 may, responsive to the request for collection and/or access, prompt the engineer or the engineering software component to fill out a PIA form, which may be provided to a privacy officer or a software component to review which data can be collected, approved usages of the collected data, and the like. In some implementations, the data location query may be associated with a data collection categorization operation and/or a data classification operation according to sensitivity levels.

In some implementations, the data governance platform 502 may be configured to respond to requests to delete personal data. In some implementations, the data governance platform 502 may receive a request to delete personal data. The data governance platform 502 may determine the location of the personal data and delete the personal data from any locations in which it is stored. Additionally, the data governance platform may identify any ML models that were trained using the personal data and may facilitate an automated process of retraining the identified ML models using data that excludes the deleted personal data.

The system 500 also includes an infrastructure 508. The infrastructure 508 provides the underlying computing resources for the system 500. The infrastructure 508 may be, be similar to, include, or be included in the platform server 402 shown in FIG. 4, the software platform 300 shown in FIG. 3, the computing device 200 shown in FIG. 2, and/or the datacenter 106 shown in FIG. 1, among other examples. In some implementations, the infrastructure 508 (or a portion thereof) may be provided by the same business entity that provides the data governance platform 502, and in some implementations, the infrastructure 508 (or a portion thereof) may be provided by a different business entity than the business entity that provides the data governance platform 502.

The data storage component 510 within the infrastructure 508 may be configured to store various types of data, including user data, system logs, and metadata. The data storage component 510 may implement different storage technologies based on data sensitivity and access requirements. For example, highly sensitive data may be stored in encrypted form on isolated storage systems, while less sensitive data may be stored in more accessible cloud storage solutions.

The compute engine 512 of the infrastructure 508 may be responsible for executing data processing tasks and computations required by other components of the system 500. For instance, the compute engine 512 may perform data anonymization operations, run ML models for data classification, or execute complex queries on large datasets. In some implementations, the compute engine 512 may utilize distributed computing techniques to process data in parallel across multiple nodes for improved performance. In the context of this disclosure, the compute engine 512 may facilitate the retraining of ML models when personal data used to train those models is deleted. For instance, the compute engine 512 may perform data anonymization operations, run ML models for data classification, and/or execute complex queries on large datasets.

The system 500 also includes a data web service 514 that includes a model manager 516 and a data processing manager 518. The data web service 514 may be, be similar to, include, or be included in the platform server 402 shown in FIG. 4, the software platform 300 shown in FIG. 3, the computing device 200 shown in FIG. 2, and/or the datacenter 106 shown in FIG. 1, among other examples. In some implementations, the data web service 514 (or a portion thereof) may be provided by the same business entity that provides the data governance platform 502, and in some implementations, the data web service 514 (or a portion thereof) may be provided by a different business entity than the business entity that provides the data governance platform 502. In some implementations, the data web service 514 (or a portion thereof) may be, be similar to, include, or be included in the infrastructure 508.

In some implementations, the data web service 514 acts as an interface between the data governance platform 502 and other components of the system 500. The model manager 516 within the data web service 514 may be responsible for managing ML models used for data classification, anomaly detection, and/or privacy risk assessment. For example, the model manager 516 may periodically update these models based on new training data and/or changing privacy regulations. In some implementations, retrieval-augmented generation (RAG) may be used to obtain domain-specific content for identifying privacy regulation changes. In some implementations, the data web service 514 may facilitate access to AI/ML technologies for use by any number of employees and/or services in an enterprise. The enterprise may include the data governance platform 502 and/or may be provided data governance services via the data governance platform 502. In the context of this disclosure, the model manager 516 may be configured to facilitate the automatic retraining of ML models upon data deletion.

The data processing manager 518 of the data web service 514 may orchestrate data processing workflows across the system 500. It may receive data processing requests, coordinate with the compute engine 512 for execution, and ensure that all data handling complies with any policies, rules, and/or data flows defined in the data governance platform 502. In some implementations, data retention and/or data deletion policies may be managed by the data processing manager 518 (e.g., in conjunction with the data governance platform 502). For instance, when processing a large dataset for analysis, the data processing manager 518 may first check data access permissions, apply necessary data masking techniques, and then distribute the processing tasks across available compute resources (e.g., provided by the compute engine 512). In the context of this disclosure, the data processing manager 518 may be involved in identifying data sets used to train ML models and coordinating the deletion of personal data from these data sets.

The system 500 also includes an enterprise access component 520. The enterprise access component 520 provides a secure gateway for enterprise users to interact with the system 500 or one or more components thereof. The enterprise access component 520 may implement authentication and authorization mechanisms to ensure that only authorized personnel can access sensitive data and/or perform certain operations. For example, the enterprise access component 520 may use multi-factor authentication and role-based access control to manage user permissions.

In some implementations, the enterprise access component 520 may be, be similar to, include, or be included in the platform server 402 shown in FIG. 4, the software platform 300 shown in FIG. 3, the computing device 200 shown in FIG. 2, and/or the datacenter 106 shown in FIG. 1, among other examples. In some implementations, the enterprise access component 520 (or a portion thereof) may be provided by the same business entity that provides the data governance platform 502, and in some implementations, the enterprise access component 520 (or a portion thereof) may be provided by a different business entity than the business entity that provides the data governance platform 502. In some implementations, the enterprise access component 520 (or a portion thereof) may be, be similar to, include, or be included in the infrastructure 508 and/or the data web service 514.

The enterprise access component 520 may facilitate access to the data web service 514 by employees of the business entity that provides the data governance platform 502. The enterprise access component 520 may be associated with a business entity other than the business entity that provides the data governance platform 502, in which cases, the enterprise access component 520 may work with the data governance platform 502 to manage data privacy associated with data compute jobs performed via the enterprise access component 520 and the data web service 514. In this implementation, the data governance platform 502 may be provided as a service to one or more customers.

The system 500 also includes an administrative component 522. The administrative component 522 may offer interfaces for system administrators to configure and/or monitor the data governance platform 502. Through this component, administrators may define data classification rules,, set up data deletion policies (e.g., to be executed at account termination or user termination), and/or configure PIA workflows. The administrative component 522 may provide the data classification rules, the data retention policies and/or the data deletion policies to the data governance platform 502 for incorporation with the data map 504 and lineage service 506. The administrative component 522 may also provide dashboards and/or reports to help administrators identify potential privacy risks or compliance issues.

In some implementations, the administrative component 522 may be, be similar to, include, or be included in or be included in the platform server 402 shown in FIG. 4, the software platform 300 shown in FIG. 3, the computing device 200 shown in FIG. 2, and/or the datacenter 106 shown in FIG. 1, among other examples. In some implementations, the administrative component 522 (or a portion thereof) may be provided by the same business entity that provides the data governance platform 502, and in some implementations, the administrative component 522 (or a portion thereof) may be provided by a different business entity than the business entity that provides the data governance platform 502. In some implementations, the administrative component 522 (or a portion thereof) may be, be similar to, include, or be included in the enterprise access component 520, the data governance platform 502, the infrastructure 508 and/or the data web service 514. In some implementations, the administrative component 522 may facilitate access to the data governance platform 502 and/or the data processing manager 518 by a user device 524.

The user device 524 represents an endpoint where data may be generated, accessed, and/or modified. The user device 524 may be a client device, such as a mobile phone, a tablet computer, a laptop computer, a notebook computer, a desktop computer, or another suitable computing device or combination of computing devices. The user device 524 may be, be similar to, include, or be included in participant device 410 shown in FIG. 4; the desk phone 304, the computer 306, the mobile device 308, or the shared device 310 shown in FIG. 3; the computing device 200 shown in FIG. 2; and/or the customer 1 102A, the customer N 102B, the client 1 104A, the client N 104B, the client 1 104C, and/or the client N 104D shown in FIG. 1, among other examples.

The user device 524 includes a client application 526 and a data tracker 528. The client application 526 is a software application installed on the user device 524 and may be used to access various services of the system 500 via one or more client-side graphical user interfaces (GUIs). The client application 526 may provide a user interface for interacting with the system, such as uploading files, requesting data access, and/or viewing privacy notices, among other examples. The client application 526 may be, be similar to, include, or be included in the client application 412 shown in FIG. 4; and/or the client 1 104A, the client N 104B, the client 1 104C, and/or the client N 104D shown in FIG. 1, among other examples.

The data tracker 528 is a software component configured to track telemetry data. The data tracker 528 within the user device 524 may monitor local data activities and report relevant events to the telemetry service 530. For instance, the data tracker 528 may log when a user accesses a sensitive document or attempts to share data outside the organization.

The telemetry data may be provided to a telemetry service 530. The telemetry service 530 may collect and process data from various sources within the system 500, including the data tracker 528 on user devices. The telemetry service 530 may aggregate and/or analyze telemetry data to identify usage patterns, detect potential security threats, and/or measure compliance with data handling policies, among other examples. For example, the telemetry service 530 may generate alerts if it detects unusual data access patterns that could indicate a potential data breach. In the context of this disclosure, the telemetry service 530 may be configured to identify when personal data is accessed or modified, which could trigger processes related to data deletion and ML model retraining.

The telemetry service 530 may be, be similar to, include, or be included in the platform server 402 shown in FIG. 4, the software platform 300 shown in FIG. 3, the computing device 200 shown in FIG. 2, and/or the datacenter 106 shown in FIG. 1, among other examples. In some implementations, the telemetry service 530 (or a portion thereof) may be provided by the same business entity that provides the data governance platform 502, and in some implementations, the telemetry service 530 (or a portion thereof) may be provided by a different business entity than the business entity that provides the data governance platform 502.

In some implementations, the system 500 may also be used to identify a data schema associated with a registration request corresponding to a telemetry event. A classification operation associated with the telemetry event may be performed based on the data schema, which may involve obtaining a set of classification labels associated with the telemetry event. A privacy impact assessment associated with the telemetry event may be performed based on the set of classification labels. An event registration indication associated with the telemetry event may be provided for output based on the privacy impact assessment.

In operation, the system 500 may identify a first data set including personal data that has been used to train an ML model. This identification may be based on information stored in the data map 504, which tracks the lineage of data used in various processes, including ML model training. When a request is received to delete personal data, the system can use the data map 504 to identify all ML models that have been trained using this data.

Upon receiving a request to delete personal data, the system 500 may delete the personal data from the data store associated with the ML model, which may be implemented in the data storage component 510. This deletion process may involve updating the data map 504 to reflect the removal of the personal data.

After deleting the personal data, the system 500 automatically initiates a retraining process for the affected ML model. This retraining is performed using a second data set that excludes the deleted personal data. The model manager 516 may coordinate this retraining process, working in conjunction with the compute engine 512 to execute the necessary computations.

The system 500 may determine a set of data attributes associated with the first data set (the original training data including the now-deleted personal data). These attributes may be used to select or generate the second data set for retraining. For example, the system 500 may identify a subset of available data that matches these attributes, ensuring that the retraining data is similar in nature to the original training data, but without including the deleted personal data.

In some cases, the system 500 may need to assess the quality and quantity of the second data set before proceeding with retraining. If the subset of data identified based on the original attributes is insufficient in quality or quantity, the system 500 may take additional steps. For instance, it may identify additional subsets of data, combine multiple subsets, or even modify the ML model itself to accommodate the changes in available training data.

The system 500 also addresses the challenge of managing data dependencies. When personal data is deleted, it may affect not just one ML model, but potentially multiple models and data processing workflows. The system 500 may determine a set of data dependencies associated with the deleted personal data and modify these dependencies as necessary. This could involve updating data processing pipelines, modifying feature extraction processes, or adjusting the inputs to multiple ML models.

By automating the process of identifying affected ML models, deleting personal data, and retraining models, the system 500 enables organizations to efficiently manage large volumes of deletion requests. This automation reduces the legal and reputational risks associated with unauthorized data retention and helps maintain compliance with evolving privacy regulations. Moreover, the system 500 may provide transparency to users about which models were retrained based on their data deletion requests. This transparency can be implemented through the client application 526, which may display notifications or reports about the actions taken in response to a user's data deletion request.

In some implementations, the system 500 could track personal data usage at different levels of granularity. Instead of tracking which specific data points were used to train each model, it could track data usage at a higher level, such as by user ID or data category. This approach may reduce storage and computational requirements while still enabling model retraining when personal data is deleted. In some implementations, instead of fully retraining models from scratch, the system may employ techniques like fine-tuning or incremental learning to update existing models. This could potentially reduce computational costs and preserve more of the model's existing knowledge.

In some implementations, the system 500 may provide different levels of detail in its transparency reports to users. For example, it could simply confirm that retraining occurred, or it could provide more detailed metrics on how model performance changed after retraining without their data. In some implementations, the system 500 could incorporate additional verification steps to confirm the influence of deleted data has been removed from retrained models. This could involve techniques like differential privacy guarantees or empirical testing to ensure no traces of the deleted data remain.

By integrating data governance, ML model management, and automated retraining processes, the system 500 may offer advantages in terms of efficiency, compliance, and risk management. Organizations implementing this system 500 can more effectively navigate the complex landscape of data privacy in the age of ML and artificial intelligence.

The system 500 may be used to address a number of challenges associated with data privacy management in the context of modern software systems. The system 500 provides enhanced visibility into data flows and locations, enabling organizations to maintain accurate and up-to-date knowledge of where sensitive information resides and how it is being used. This visibility may facilitate complying with data protection regulations and responding effectively to data subject access requests and requests to delete personal data.

The system 500 also offers significant advantages in terms of automation and efficiency. By integrating data governance, processing, and monitoring components, the system 500 can automate many aspects of data privacy management, reducing the need for time-consuming manual processes. For instance, the system 500 can automatically classify new datasets, apply appropriate access controls, and track data lineage without requiring constant human intervention.

The system 500 may automate the review process for data classification, trigger compliance reviews, and provide a feedback loop for approvals. The system 500 may also provide, for display as part of a GUI, data configured to cause the GUI to present a dashboard comprising information associated with at least one of a data privacy compliance assessment, a data privacy risk, a set of data assets, a data classification scan operation, a data classification labeling operation, and/or a data subject request, among other examples.

The system 500 also addresses the challenge of ensuring compliance with evolving data protection regulations. The system 500 may automatically perform a data privacy compliance assessment, generate, based on the data privacy compliance assessment, a task associated with a data privacy compliance gap, and provide an indication of the task to a software service. The system 500 may also be used to configure a set of data privacy policies based on the data map 504. The system 500 may also perform an automated audit operation on a data privacy policy based on a time-based trigger event, and re-configuring the data privacy policy based on the automated audit operation.

Furthermore, the system's ability to perform real-time monitoring and analysis through components like the telemetry service 530 and the lineage service 506 enables proactive risk management. Organizations can quickly identify and address potential privacy issues before they escalate into more serious problems, thereby reducing the risk of data breaches and regulatory violations.

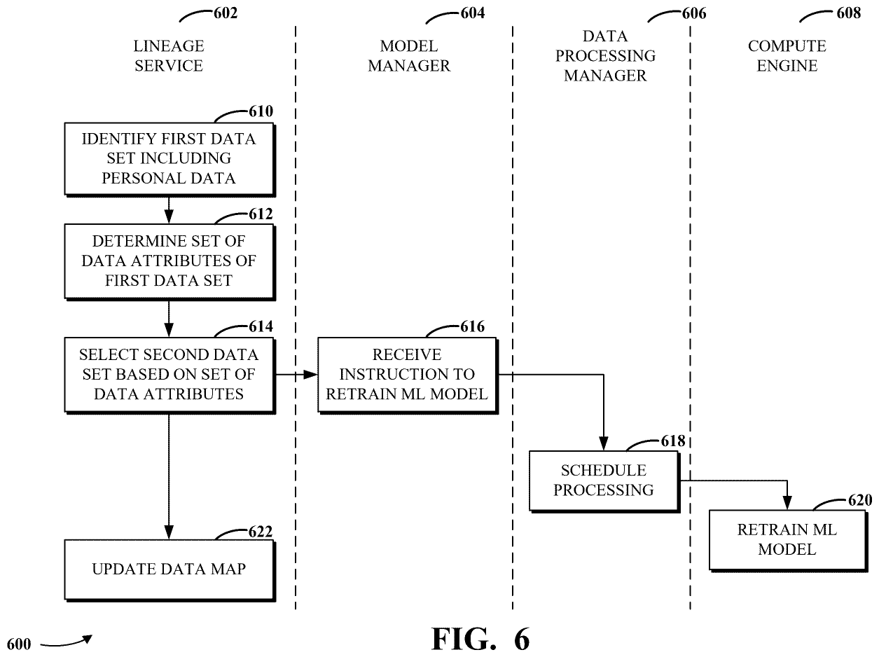

FIG. 6 is a schematic block diagram of an example 600 associated with automatic retraining of ML models upon data deletion. The example 600 includes a lineage service 602, a model manager 604, a data processing manager 606, and a compute engine 608. The lineage service 602 may be, be similar to, include, or be included in the lineage service 506 shown in FIG. 5. The model manager 64 may be, be similar to, include, or be included in the model manager 516 shown in FIG. 5. The data processing manager 606 may be, be similar to, include, or be included in the data processing manager 518 shown in FIG. 5. The compute engine 608 may be, be similar to, include, or be included in the compute engine 512 shown in FIG. 5.

In block 610, the lineage service 602 identifies a first data set including personal data. The identification process may involve querying the data map to locate datasets containing personal information used in model training. Following the identification, in block 612, the lineage service 602 determines a set of data attributes of the first data set. This step may facilitate maintaining the quality and relevance of the training data after personal data deletion. The data attributes may include features such as data types, statistical properties, and/or metadata associated with the original dataset.

In block 614, the lineage service 602 selects a second data set based on the set of data attributes. This selection process ensures that the new dataset used for retraining closely resembles the original dataset in terms of relevant characteristics, while excluding the deleted personal data. In some implementations, this selection may involve complex algorithms that consider multiple factors to find the most suitable replacement data.

The model manager 604 comes into play in block 616, where it receives an instruction to retrain an ML model. This instruction is triggered based on the operations performed by the lineage service 602. The model manager 604 may coordinate the retraining process across multiple models, if necessary, as the deleted personal data might have been used to train various models within the system.

In block 618, the data processing manager 606 may schedule the processing of the second data set for retraining the ML model. This step may involve prioritizing the retraining task, allocating necessary computational resources, and ensuring that the process complies with data governance policies. The compute engine 608 executes the actual retraining in block 620, using the second data set that excludes the personal data. The compute engine 608 may employ various ML algorithms and techniques to efficiently retrain the model while maintaining its performance.

In block 622, the lineage service 602 updates the data map based on the operations performed. This step ensures that the system maintains an accurate record of data usage, model training history, and personal data removal. The updated data map serves as a reference for future data management and compliance activities.

In some implementations, the system may employ a federated learning approach. In this scenario, the compute engine 608 could coordinate with multiple distributed devices or servers to retrain the model without centralizing the data. This approach may enhance privacy and reduce data transfer requirements. In some implementations, differential privacy techniques may be used during the retraining process. For example, the compute engine 608 could apply noise to the training data or model parameters to provide additional privacy guarantees, even with the second data set that excludes personal data.

The system may also implement a rollback mechanism. If the retrained model's performance degrades significantly after using the second data set, the model manager 604 could initiate a process to revert to a previous version of the model while still ensuring the exclusion of deleted personal data. In some cases, the lineage service 602 may determine that suitable replacement data is not immediately available. In such scenarios, the system could implement a temporary model freezing mechanism, where the affected model is taken offline until appropriate new training data can be acquired or generated.

The example 600 may also incorporate a continuous monitoring component (not shown in the diagram) that assesses the performance of retrained models over time. This component could work in conjunction with the model manager 604 to trigger additional retraining or adjustments if the model's accuracy or fairness metrics drift beyond acceptable thresholds after the initial retraining. Additionally, in some implementations, the system could include a user notification feature. After the retraining process is complete, it may generate a report or alert, informing relevant stakeholders about the models that were retrained, the nature of the data removed, and any significant changes in model performance. This feature enhances transparency and aids in regulatory compliance efforts.

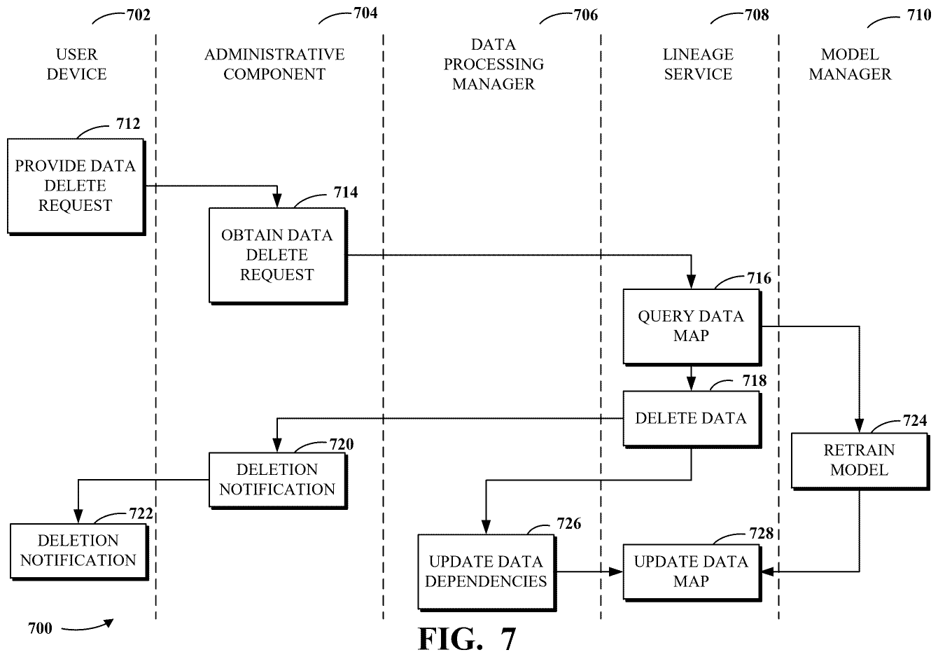

FIG. 7 is a schematic block diagram of an example 700 associated with automatic retraining of ML models upon data deletion. The example 700 includes a user device 702, an administrative component 704, a data processing manager 706, a lineage service 708, and a model manager 710. The user device 702 may be, be similar to, include, or be included in the user device 524 shown in FIG. 5. The administrative component 704 may be, be similar to, include, or be included in the administrative component 522 shown in FIG. 5. The data processing manager 706 may be, be similar to, include, or be included in the data processing manager 518 shown in FIG. 5. The lineage service 708 may be, be similar to, include, or be included in the lineage service 506 shown in FIG. 5. The model manager 710 may be, be similar to, include, or be included in the model manager 516 shown in FIG. 5.

In block 712, the user device 702 provides a data delete request. This request may be initiated by a user who wishes to have their personal data removed from the system. The data delete request is then obtained by the administrative component 704 in block 714. The administrative component 704 may serve as an interface between the user and the system's internal processes, managing user requests and system responses. In some implementations, the administrative component 704 may include additional security measures to verify the authenticity of the delete request.

Upon receiving the delete request, in block 716, the data processing manager 706 queries a data map to identify the locations and usage of the personal data to be deleted. This step may facilitate ensuring comprehensive data removal and may involve complex data lineage tracking mechanisms. The data map query may utilize various data attributes to locate all instances of the personal data across different datasets and models. The lineage service 708, in block 718, performs the deletion of the identified personal data from the relevant data stores. The lineage service 708 may employ secure deletion techniques to ensure that the data is irrecoverable. After the deletion is complete, the administrative component 704 generates a deletion notification in block 720. This notification is then sent to the user device 702, where it is received in block 722. This step enhances transparency and provides confirmation to the user that their data deletion request has been processed.

The model manager 710, in block 724, initiates the retraining of the affected ML models. The retraining process may involve complex algorithms to ensure that the model's performance is maintained or improved despite the removal of the personal data. The data processing manager 706 updates data dependencies in block 726. This step may facilitate maintaining the integrity of the system's data relationships after the deletion of personal data. It may involve adjusting data processing pipelines, modifying feature extraction processes, and/or updating the inputs to multiple ML models. In block 728, the lineage service 708 updates the data map to reflect the changes made during the deletion and retraining processes. This ensures that the system maintains an accurate record of data usage and model training history, which may facilitate ongoing compliance and data management efforts.

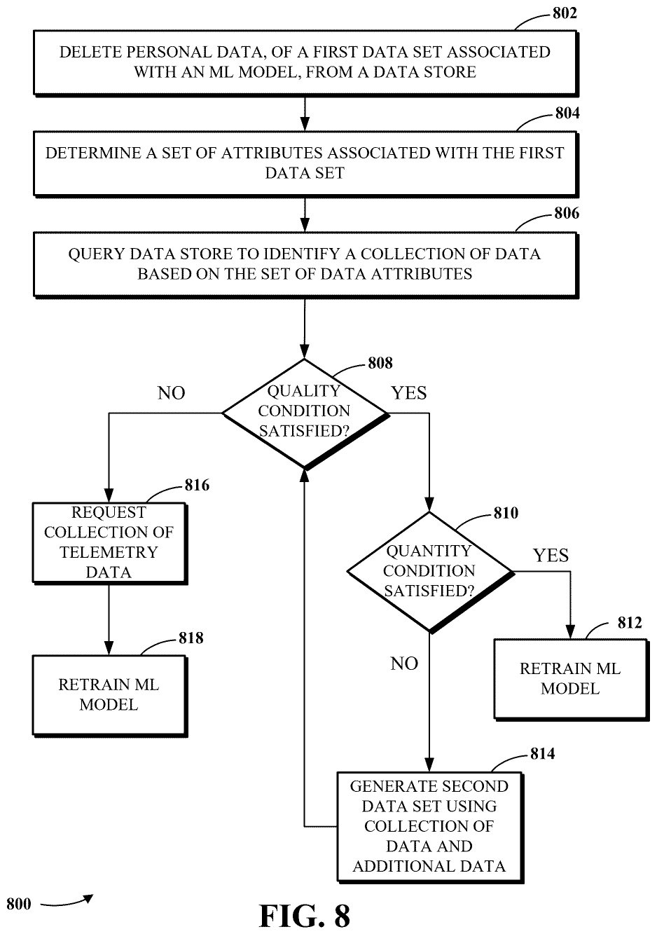

To further describe some implementations in greater detail, reference is next made to examples of techniques which may be performed by or using a system for automatic retraining of ML models upon data deletion. FIG. 8 is a flowchart of an example of a technique 800 for automatic retraining of ML models upon data deletion. The technique 800 can be executed using computing devices, such as the systems, hardware, and software described with respect to FIGS. 1-7. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations of the technique 800 can occur in various orders and/or concurrently. Additionally, other steps or operations not presented and described herein may be used. Furthermore, not all illustrated steps or operations may be required to implement a technique in accordance with the disclosed subject matter.

The technique 800 begins at step 802, where personal data of a first data set associated with an ML model is deleted from a data store. In some implementations, this deletion may be triggered by a user request, a data retention policy, and/or a regulatory requirement. For example, the system may receive a DSDR from a user exercising their right to be forgotten under privacy regulations such as GDPR or CCPA.

In step 804, the technique 800 includes determining a set of attributes associated with the first data set. The set of attributes may include various characteristics of the data, such as data types, statistical properties, and/or metadata, among other examples. For instance, in a natural language processing model, attributes might include vocabulary size, language distribution, and/or topic categories. In an image recognition model, attributes could include image resolution, color depth, and/or object classes represented in the dataset.

In step 806, the technique 800 includes querying the data store to identify a collection of data based on the set of data attributes. The query may utilize advanced data retrieval techniques to find suitable replacement data that matches the attributes of the deleted personal data. For example, the system may use similarity measures or clustering algorithms to identify data points with similar characteristics to the deleted data.

At step 808, the technique 800 includes evaluating whether a quality condition is satisfied. This quality check ensures that the identified collection of data meets certain standards before being used for model retraining. The quality condition may encompass various criteria, such as data accuracy, completeness, consistency, and/or relevance to the model's task. For instance, in a financial fraud detection model, the quality condition might include checks for data integrity, proper formatting of financial transactions, and/or the presence of key features used in fraud identification.

If the quality condition is not satisfied (NO branch from step 808), the technique 800 moves to step 816, which includes requesting a collection of telemetry data. This step demonstrates the system's ability to adapt when suitable replacement data is not readily available. The telemetry data request may involve collecting additional information from various sources, such as user interactions, system logs, and/or external data providers. For example, in an e-commerce recommendation system, the technique might include requesting recent user browsing and purchase data to supplement the training dataset.

Following the telemetry data collection, or if the quality condition is satisfied (YES branch from step 808), the technique 800 proceeds to step 810, which includes evaluating whether a quantity condition is satisfied. This step ensures that there is sufficient data for effective model retraining. The quantity condition may vary depending on the specific requirements of the ML model and the complexity of the task it performs. For instance, a simple linear regression model might require fewer data points to retrain effectively compared to a deep neural network for image classification.

If the quantity condition is satisfied (YES branch from step 810), the technique 800 moves to step 812, which includes retraining the ML model. The retraining process may involve various ML algorithms and techniques, such as transfer learning, fine-tuning, or complete retraining from scratch, depending on the nature of the model and the extent of the data changes.

If the quantity condition is not satisfied (NO branch from step 810), the technique 800 proceeds to step 814, which includes generating a second data set using the collection of data and additional data. This step demonstrates the system's ability to augment the available data when necessary. The additional data may come from various sources, such as synthetic data generation techniques, data augmentation methods, and/or external datasets. For example, in a speech recognition model, the system might use techniques like speed perturbation or pitch shifting to create additional training samples from the existing audio data.

At step 818, the technique 800 includes retraining the ML model. This step ensures that the model is updated to exclude the influence of the deleted personal data while maintaining its performance and functionality. The retraining process may involve adjusting model parameters, updating feature representations, and/or even modifying the model architecture if necessary. For instance, in a recommendation system, the retraining might involve updating user embeddings and item features to reflect the removal of certain user data.

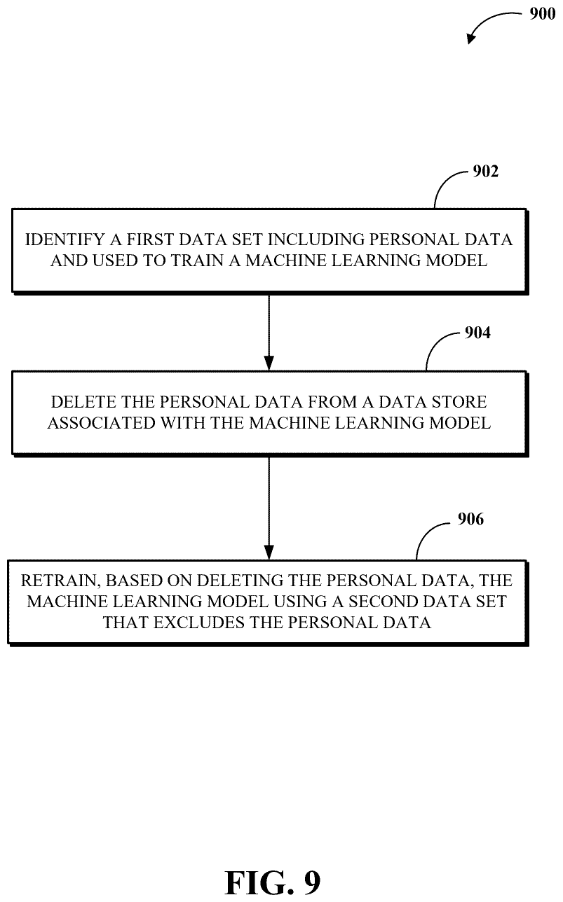

FIG. 9 is a flowchart of another example of a technique 900 for automatic retraining of ML models upon data deletion. The technique 900 can be executed using computing devices, such as the systems, hardware, and software described with respect to FIGS. 1-7. The technique 900 can be performed, for example, by executing a machine-readable program or other computer-executable instructions, such as routines, instructions, programs, or other code. The steps, or operations, of the technique 900, or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations of the technique 900 can occur in various orders and/or concurrently. Additionally, other steps or operations not presented and described herein may be used. Furthermore, not all illustrated steps or operations may be required to implement a technique in accordance with the disclosed subject matter.

At 902, the technique 900 includes identifying a first data set including personal data and used to train an ML model. At 904, the technique 900 includes deleting the personal data from a data store associated with the ML model. In some implementations, the technique 900 may include receiving a request to delete the personal data and deleting the personal data based on the request. In some implementations, the ML model may be identified based on the request and a data map. The data map may be updated based on deleting the personal data. In some implementations, the techniques may include generating a data map indicative of a lineage associated with the personal data and updating the data map based on deleting the personal data.

At 906, the technique 900 includes retraining, based on deleting the personal data, the ML model using a second data set that excludes the personal data. In some implementations, the first data set consists of the personal data and remaining data, and the second data set consists of the remaining data. In some implementations, the technique 900 may include outputting, for display at a user device (e.g., a user device from which a request to delete the personal data is received), a delete notification indicative of deletion of the personal data.

In some implementations, the technique 900 includes determining that the second data set excludes additional personal data, where retraining the ML model comprises retraining the ML model based on determining that the second data set excludes the additional personal data. In some implementations, the technique 900 includes identifying an additional ML model trained using the personal data and retraining, based on deleting the personal data, the additional ML model using a third data set that excludes the personal data.

In some implementations, the technique 900 includes determining a set of data attributes associated with the first data set and selecting the second data set based on the set of data attributes. In some implementations, the technique 900 includes determining, based on a data map, the set of data attributes associated with the first data set and identifying, based on the data map and the set of data attributes, the second data set. In some implementations, the technique 900 includes determining a set of data attributes associated with the first data set, identifying a subset of the second data set based on the set of data attributes, determining that the subset satisfies a quality condition, and generating the second data set based on determining that the subset satisfies the quality condition. In some implementations, the technique 900 further includes determining that the subset satisfies a quantity condition, where the second data set is the subset.

In some implementations, the technique 900 includes determining that the subset fails to satisfy a quantity condition, identifying an additional subset of the second data set based on the set of data attributes, and generating the second data set by combining the subset with the additional subset. In some implementations, the technique 900 includes determining a set of data attributes associated with the first data set, identifying a subset of the second data set based on the set of data attributes, determining that the subset fails to satisfy a quality condition, and providing, to a telemetry service and based on determining that the subset fails to satisfy the quality condition, a telemetry request for a collection of telemetry data.

In some implementations, the technique 900 includes determining a set of data dependencies associated with the first data set and modifying the set of data dependencies based on deleting the personal data. In some implementations, the technique 900 includes determining a set of data attributes associated with the first data set, identifying a subset of the second data set based on the set of data attributes, determining that the subset fails to satisfy a quality condition, and modifying the ML model based on determining that the subset fails to satisfy the quality condition. In some implementations, the technique 900 includes determining a set of data attributes associated with the first data set, determining at least one of a set of data dependencies associated with the first data set or a set of two or more ML models, including the ML model, associated with the first data set, and modifying at least one of the set of data dependencies or the set of two or more ML models.

Some implementations include a method, comprising: identifying a first data set including personal data, wherein the first data set is used to train a machine learning model; deleting the personal data from a data store associated with the machine learning model; and retraining, based on deleting the personal data, the machine learning model using a second data set that excludes the personal data.

In some implementations, the method further comprises: determining a set of data attributes associated with the first data set; and selecting the second data set based on the set of data attributes.

In some implementations, the method further comprises: determining a set of data attributes associated with the first data set; identifying a subset of the second data set based on the set of data attributes; determining that the subset satisfies a quality condition; and generating the second data set based on determining that the subset satisfies the quality condition.

In some implementations, the method further comprises: determining a set of data attributes associated with the first data set; identifying a subset of the second data set based on the set of data attributes; determining that the subset fails to satisfy a quality condition; and providing, to a telemetry service and based on determining that the subset fails to satisfy the quality condition, a telemetry request for a collection of telemetry data.

In some implementations, the method further comprises: determining a set of data dependencies associated with the first data set; and modifying the set of data dependencies based on deleting the personal data.

In some implementations, the method further comprises: determining a set of data attributes associated with the first data set; identifying a subset of the second data set based on the set of data attributes; determining that the subset fails to satisfy a quality condition; and modifying the machine learning model based on determining that the subset fails to satisfy the quality condition.

In some implementations, the method further comprises: determining a set of data attributes associated with the first data set; determining at least one of a set of data dependencies associated with the first data set or a set of two or more machine learning models, including the machine learning model, associated with the first data set; and modifying at least one of the set of data dependencies or the set of two or more machine learning models.

In some implementations, the method further comprises: receiving a request to delete the personal data, wherein deleting the personal data comprises deleting the personal data based on the request; andoutputting, for display, an indication that the personal data was deleted and an indication associated with the retraining of the machine learning model.

Some implementations include a non-transitory computer readable medium storing instructions operable to cause one or more processors to perform operations comprising: identifying a first data set including personal data, wherein the first data set is used to train a machine learning model; deleting the personal data from a data store associated with the machine learning model; and retraining, based on deleting the personal data, the machine learning model using a second data set that excludes the personal data.

In some implementations, the operations further comprise: generating a data map indicative of a lineage associated with the personal data; and updating the data map based on deleting the personal data.

In some implementations, the operations further comprise: determining, based on a data map, a set of data attributes associated with the first data set; and identifying, based on the data map and the set of data attributes, the second data set.

In some implementations, the operations further comprise: determining a set of data attributes associated with the first data set; identifying a subset of the second data set based on the set of data attributes; determining that the subset satisfies a quality condition; and determining that the subset satisfies a quantity condition, wherein the second data set is the subset.

In some implementations, the operations further comprise: determining a set of data attributes associated with the first data set; identifying a subset of the second data set based on the set of data attributes; determining that the subset satisfies a quality condition; determining that the subset fails to satisfy a quantity condition; identifying an additional subset of the second data set based on the set of data attributes; and generating the second data set by combining the subset with the additional subset.

In some implementations, the first data set consists of the personal data and remaining data, and wherein the second data set consists of the remaining data.

In some implementations, the operations further comprise: receiving a request to delete the personal data; and identifying the machine learning model based on the request and a data map.

Some implementations include a system, comprising: a memory subsystem storing instructions; and processing circuitry configured to execute the instructions to cause the system to: identify a first data set including personal data, wherein the first data set is used to train a machine learning model; delete the personal data from a data store associated with the machine learning model; and retrain, based on deleting the personal data, the machine learning model using a second data set that excludes the personal data.

In some implementations, the processing circuitry is configured to execute the instructions to further cause the system to: update a data map based on deleting the personal data.

In some implementations, the processing circuitry is configured to execute the instructions to further cause the system to: identify an additional machine learning model trained using the personal data; and retraining, based on deleting the personal data, the additional machine learning model using a third data set that excludes the personal data.

In some implementations, the processing circuitry is configured to execute the instructions to further cause the system to: determining, based on a data map, a set of data attributes associated with the first data set; identifying, based on the data map and the set of data attributes, the second data set; and determining that the second data set excludes additional personal data, wherein retraining the machine learning model comprises: retraining the machine learning model based on determining that the second data set excludes additional personal data.

In some implementations, the processing circuitry is configured to execute the instructions to further cause the system to: receive, from a user device, a request to delete the personal data; identify the machine learning model based on the request; and output, for display at the user device, a delete notification indicative of deletion of the personal data.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
identifying a first data set including personal data, wherein the first data set is used to train a machine learning model;
deleting the personal data from a data store associated with the machine learning model; and
retraining, based on deleting the personal data, the machine learning model using a second data set that excludes the personal data.

2. The method of claim 1, further comprising:
determining a set of data attributes associated with the first data set; and
selecting the second data set based on the set of data attributes.

3. The method of claim 1, further comprising:
determining a set of data attributes associated with the first data set;
identifying a subset of the second data set based on the set of data attributes;
determining that the subset satisfies a quality condition; and
generating the second data set based on determining that the subset satisfies the quality condition.

4. The method of claim 1, further comprising:
determining a set of data attributes associated with the first data set;
identifying a subset of the second data set based on the set of data attributes;
determining that the subset fails to satisfy a quality condition; and
providing, to a telemetry service and based on determining that the subset fails to satisfy the quality condition, a telemetry request for a collection of telemetry data.

5. The method of claim 1, further comprising:
determining a set of data dependencies associated with the first data set; and
modifying the set of data dependencies based on deleting the personal data.

6. The method of claim 1, further comprising:
determining a set of data attributes associated with the first data set;
identifying a subset of the second data set based on the set of data attributes;
determining that the subset fails to satisfy a quality condition; and
modifying the machine learning model based on determining that the subset fails to satisfy the quality condition.

7. The method of claim 1, further comprising:
determining a set of data attributes associated with the first data set;
determining at least one of a set of data dependencies associated with the first data set or a set of two or more machine learning models, including the machine learning model, associated with the first data set; and
modifying at least one of the set of data dependencies or the set of two or more machine learning models.

8. The method of claim 1, further comprising:
receiving a request to delete the personal data, wherein deleting the personal data comprises deleting the personal data based on the request; and
outputting, for display, an indication that the personal data was deleted and an indication associated with the retraining of the machine learning model.

9. A non-transitory computer readable medium storing instructions operable to cause one or more processors to perform operations comprising:
identifying a first data set including personal data, wherein the first data set is used to train a machine learning model;
deleting the personal data from a data store associated with the machine learning model; and
retraining, based on deleting the personal data, the machine learning model using a second data set that excludes the personal data.

10. The non-transitory computer readable medium of claim 9, the operations further comprising:
generating a data map indicative of a lineage associated with the personal data; and
updating the data map based on deleting the personal data.

11. The non-transitory computer readable medium of claim 9, the operations further comprising:
determining, based on a data map, a set of data attributes associated with the first data set; and
identifying, based on the data map and the set of data attributes, the second data set.

12. The non-transitory computer readable medium of claim 9, the operations further comprising:
determining a set of data attributes associated with the first data set;
identifying a subset of the second data set based on the set of data attributes;
determining that the subset satisfies a quality condition; and
determining that the subset satisfies a quantity condition, wherein the second data set is the subset.

13. The non-transitory computer readable medium of claim 9, the operations further comprising:
determining a set of data attributes associated with the first data set;
identifying a subset of the second data set based on the set of data attributes;
determining that the subset satisfies a quality condition;
determining that the subset fails to satisfy a quantity condition;
identifying an additional subset of the second data set based on the set of data attributes; and
generating the second data set by combining the subset with the additional subset.

14. The non-transitory computer readable medium of claim 9, wherein the first data set consists of the personal data and remaining data, and wherein the second data set consists of the remaining data.

15. The non-transitory computer readable medium of claim 9, the operations further comprising:
receiving a request to delete the personal data; and
identifying the machine learning model based on the request and a data map.

16. A system, comprising:
a memory subsystem storing instructions; and
processing circuitry configured to execute the instructions to cause the system to:
identify a first data set including personal data, wherein the first data set is used to train a machine learning model;
delete the personal data from a data store associated with the machine learning model; and
retrain, based on deleting the personal data, the machine learning model using a second data set that excludes the personal data.

17. The system of claim 16, wherein the processing circuitry is configured to execute the instructions to further cause the system to:
update a data map based on deleting the personal data.

18. The system of claim 16, wherein the processing circuitry is configured to execute the instructions to further cause the system to:
identify an additional machine learning model trained using the personal data; and
retraining, based on deleting the personal data, the additional machine learning model using a third data set that excludes the personal data.

19. The system of claim 16, wherein the processing circuitry is configured to execute the instructions to further cause the system to:
determining, based on a data map, a set of data attributes associated with the first data set;
identifying, based on the data map and the set of data attributes, the second data set; and
determining that the second data set excludes additional personal data, wherein retraining the machine learning model comprises:
retraining the machine learning model based on determining that the second data set excludes additional personal data.

20. The system of claim 16, wherein the processing circuitry is configured to execute the instructions to further cause the system to:
receive, from a user device, a request to delete the personal data;
identify the machine learning model based on the request; and
output, for display at the user device, a delete notification indicative of deletion of the personal data.
